(19) United States
(12) Patent Application Publication
(10) Pub. No.: US 2026/0307989 A1
(43) Pub. Date: Oct. 8, 2026

(54) PROCESS AND APPARATUS FOR HYDROGEN PRODUCTION WITH LOW CARBON DIOXIDE LEVELS

(71) Applicant: LINDE GMBH, Pullach (DE)

(72) Inventors: Andreas SELIGER, Pullach (DE); Thomas HASELSTEINER, Pullach (DE); Josef SCHWARZHUBER, Pullach (DE); Ole MÜLLER-THORWART, Pullach (DE)

(21) Appl. No.: 19/481,789

(22) PCT Filed: Apr. 4, 2024
(86) PCT No.: PCT/EP2024/025144

§ 371 Date: Nov. 5, 2025

(30) Foreign Application Priority Data
May 5, 2023 (EP) 23020211.1

(51) Int. Cl. C01B 3/58

(52) U.S. Cl. CPC C01B 3/586; C01B 2203/0205; C01B 2203/025; C01B 2203/0283; C01B 2203/043; C01B 2203/0445; C01B 2203/0475; C01B 2203/0822

(57) ABSTRACT

A process and an apparatus for producing a hydrogen product, in which a carbonaceous feed is converted by reforming and water gas conversion in order to obtain a hydrogen- and carbon dioxide-containing gas mixture referred to as synthesis gas, from which, in a first CO₂ separation step, the removal of carbon dioxide gives rise to crude hydrogen, and this is processed by at least one further process step to give the hydrogen product, wherein process heat is obtained by combustion of a fuel and carbon dioxide separated from the synthesis gas is disposed of by sequestration or sent to a physical use. The characteristic feature here is that the synthesis gas is separated into a first and a second synthesis gas substream, of which the first is treated in the first CO₂ separation step in order to obtain the crude hydrogen.

### DESCRIPTION

The invention relates to a process for producing a hydrogen product, in which a carbonaceous feed is converted by reforming and water gas conversion in order to obtain a hydrogen-and carbon dioxide-containing gas mixture referred to as synthesis gas, from which, in a first CO₂ separation step, the removal of carbon dioxide gives rise to crude hydrogen, and this is processed by at least one further process step to give the hydrogen product, wherein process heat is obtained by combustion of a fuel and carbon dioxide separated from the synthesis gas is disposed of by sequestration or sent to a physical use.

Hydrogen products, such as crude hydrogen, which consists of at least 99.5 mol % hydrogen, or ammonia synthesis gas, in which hydrogen and nitrogen are present in a ratio of 3:1, are still predominantly produced from carbonaceous feeds, generating and releasing large amounts of climate-damaging carbon dioxide. However, there are increasing efforts to dispose of the resulting carbon dioxide by sequestration or physical use rather than releasing it into the atmosphere.

According to the prior art, to produce a hydrogen product, a carbonaceous feed, such as natural gas, is optionally desulfurized and then converted by partial oxidation, autothermal reforming, steam reforming or a combination of two or more of these processes into a gas mixture known as synthesis crude gas, which consists largely of hydrogen, carbon monoxide and carbon dioxide and which may also contain other substances, such as hydrogen sulfide or argon. The synthesis crude gas is then subjected to a water gas conversion in order to convert the carbon monoxide it contains with water into hydrogen and carbon dioxide and to obtain a synthesis gas consisting largely of hydrogen and carbon dioxide. In a CO₂ separation step, typically performed as acid gas scrubbing, carbon dioxide is separated from the synthesis gas, yielding a carbon dioxide fraction with a purity sufficient for its sequestration or physical use, as well as a hydrogen fraction known as crude hydrogen, which contains residues of carbon monoxide, carbon dioxide and methane and whose hydrogen content is usually approximately 98 mol %.

To form the hydrogen product, the crude hydrogen is treated, for example, by methanation, nitrogen scrubbing or pressure swing adsorption, wherein carbon monoxide is converted or separated together with carbon dioxide in a residual gas and a largely carbon-free hydrogen fraction is produced, which forms the hydrogen product or from which, for example by adding nitrogen, an ammonia synthesis gas is obtained as the hydrogen product.

Acid gas scrubbing utilizes the ability of liquids to selectively absorb carbon dioxide and other acid gases from a gas mixture and keep them in solution. The higher the pressure at which the scrubbing is carried out, the better the acid gases are absorbed and separated from the gas mixture to be cleaned. Since the synthesis gas is produced at a pressure level typically between 25 and 45 bar, the volume flows to be treated are small, so that the synthesis gas can be treated by acid gas scrubbing with comparatively low investment and operating costs.

Carbon dioxide is also present in flue gases produced during the production of hydrogen products in reformers and/or furnaces, which typically combust natural gas or carbonaceous residual gases for heating. Unlike the synthesis gas, the flue gases are without pressure. Since they can therefore only be treated by acid gas scrubbing, which is very costly and laborious, they are usually released into the atmosphere together with the carbon dioxide produced during combustion.

Therefore, using the methods described, only a maximum of 95% of the carbon used to produce the hydrogen product can be separated in the form of carbon dioxide and disposed of by sequestration or sent to a physical use. Depending on legal requirements and penalties for carbon dioxide emissions, it may be necessary to achieve higher carbon capture rates.

The object of the invention is to specify a process of the generic type and an apparatus for carrying out said process, which allow the production of hydrogen products with significantly lower carbon dioxide release than in the prior art.

This object is achieved according to the invention in that the synthesis gas is separated into a first and a second synthesis gas substream, of which the first is treated in the first CO₂ separation step in order to obtain the crude hydrogen, while a combustion gas consisting largely of hydrogen is formed from the second synthesis gas substream by the removal of carbon dioxide in a second CO₂ separation step and is combusted to obtain process heat.

The combustion gas formed from the second synthesis gas substream in the second CO₂ separation step contains only small amounts of carbon compounds, such as carbon dioxide, carbon monoxide or methane, so that its combustion produces a largely carbon dioxide-free flue gas. It is expedient to completely dispose of the carbon dioxide, which were separated from the synthesis gas in both the first and second CO₂ separation steps, by sequestration or physical use. Since the combustion gas replaces at least a portion of the carbonaceous fuels used in the process according to the prior art, the amount of carbon dioxide released into the atmosphere during the production of the hydrogen product is reduced compared to the prior art.

Preferably, sufficient synthesis gas is sent to the second CO₂ separation step via the second synthesis gas substream to obtain a combustion gas quantity sufficient to fully cover the fuel demand for hydrogen production. Particularly preferably, no more combustion gas is produced than is needed to fully cover the fuel demand for producing the hydrogen product. However, it is also possible to produce a larger quantity of combustion gas and export combustion gas that cannot be used in the process in return for a credit.

Various separation methods are known from the prior art for separating carbon dioxide from synthesis gas, each of which can be used in both the first and second CO₂ separation steps. In particular, combination processes comprising membrane separation, pressure swing adsorption (PSA) and cryogenic gas separation can be used in a CO₂ separation step. Preferably, however, at least one of the two CO₂ separation steps is carried out as acid gas scrubbing, in which, for example, an alkaline aqueous amine solution serves as the scrubbing agent.

Particularly preferably, the first and second CO₂ separation steps are carried out as acid gas scrubbing, wherein the same scrubbing agent is used in both acid gas scrubbing steps. In this case, both acid gas scrubbing steps can be operated such that the scrubbing agent loaded with carbon dioxide in the first acid gas scrubbing step is regenerated together with the scrubbing agent loaded with carbon dioxide in the second acid gas scrubbing step. Apart from the optionally shared scrubbing agent regeneration unit, the two acid gas scrubbing steps are expediently operated independently of one another, making it possible to individually optimize the carbon dioxide contents of the crude hydrogen and combustion gas. For example, it may be economically viable to operate the second acid gas scrubbing step with a lower carbon dioxide removal rate than the first acid gas scrubbing step.

Preferably, the combustion gas formed is combusted to generate the steam required for the process or to preheat a feedstock for reforming. It is also possible to heat a steam reformer or a pre-reformer used for reforming with the combustion gas.

The process according to the invention is particularly suitable for use in ammonia synthesis, wherein the crude hydrogen gives rise to an ammonia synthesis gas by methanation, nitrogen scrubbing or nitrogen addition.

The conversion of the carbonaceous feed can be carried out in the process according to the invention by partial oxidation, autothermal reforming, steam reforming or a combination of two or more of these processes, which may be preceded by pre-reforming. The process according to the invention can be used with particular advantage when the carbonaceous feed is converted by autothermal reforming or partial oxidation. Unlike the use of a steam reformer, in these cases only small furnaces are heated, for example those used to heat feedstocks or generate steam, releasing comparatively small amounts of flue gas into the atmosphere. In order to cover the fuel demand of these furnaces with a combustion gas consisting largely of hydrogen, only a small portion of the synthesis gas needs to be treated in the second CO₂ separation step, so that the second CO₂ separation step can be realized with low investment costs.

Furthermore, the invention relates to an apparatus for producing a hydrogen product, with a reforming device and a water gas converter connected to the reforming device, via which a carbonaceous feed can be converted into a synthesis gas containing hydrogen and carbon dioxide by reforming and water gas conversion, a first CO₂ separation device with which carbon dioxide can be separated from the synthesis gas in order to obtain crude hydrogen, which can give rise to the hydrogen product in at least one processing device connected to the first CO₂ separation device, and a combustion device in which a fuel can be combusted to generate process heat, wherein carbon dioxide separated from the synthesis gas can be disposed of by sequestration or sent to a physical use.

The stated object is achieved by the apparatus according to the invention in that it comprises a second CO₂ separation device which is connected to the first CO₂ separation device via a flow divider, via which the synthesis gas can be divided into a first synthesis gas substream for introduction into the first CO₂ separation device and a second synthesis gas substream for introduction into the second CO₂ separation device, wherein the crude hydrogen can be obtained from the first synthesis gas substream in the first CO₂ separation device and carbon dioxide can be separated from the second synthesis gas substream in the second CO₂ separation device in order to obtain a combustion gas consisting largely of hydrogen for use in the combustion device.

Preferably, the carbon dioxide that can be separated in both the first and the second CO₂ separation devices can be completely disposed of by sequestration or sent to a physical use.

Both CO₂ separation devices are devices known from the prior art for separating carbon dioxide from synthesis gas. In particular, at least one of the two CO₂ separation devices can be designed as a combination of membrane separation, pressure swing adsorption and cryogenic gas separation. Preferably, however, at least one of the two CO₂ separation devices is an acid gas scrubber, which can be operated, for example, with an alkaline aqueous amine solution as a scrubbing agent.

The first and second CO₂ separation devices are expediently designed as acid gas scrubbers. This variant of the apparatus according to the invention allows for a reduction in investment costs and footprint by providing a scrubbing agent regeneration unit that can be used simultaneously by the first and second CO₂ separation devices and connects the two acid gas scrubbers.

The combustion device is, for example, a burner-fired furnace with which a feed to be fed to the reforming device can be heated. However, the combustion device can also be a burner-fired steam generator that can be used to generate process steam, or a steam reformer or a pre-reformer of the reforming device that can be heated via a burner.

One embodiment of the apparatus according to the invention provides a processing device comprising pressure swing adsorption that allows crude hydrogen with a hydrogen content of more than 99.5 mol % to be obtained from the crude hydrogen. The crude hydrogen can be released as a hydrogen product or further processed to produce a hydrogen product.

Preferably, the processing device is connected to an ammonia synthesis plant and designed to process the crude hydrogen into an ammonia synthesis gas which can be fed to the ammonia synthesis plant as feed gas. The processing device may, for example, comprise pressure swing adsorption for producing crude hydrogen and a nitrogen supply through which the crude hydrogen can be mixed with the ammonia synthesis gas. However, it is also possible for the processing device to comprise a mechanized or partial condensation or nitrogen scrubbing.

A reforming device particularly suitable for the apparatus according to the invention is designed with an autothermal reformer or a partial oxidation reactor, which only require a fuel for burner-fired auxiliary units, such as furnaces used to heat feedstocks, which is why only a small amount of synthesis gas needs to be diverted to obtain the combustion gas consisting largely of hydrogen in order to be able to produce the hydrogen product with no or only very little release of carbon dioxide into the atmosphere. However, it should not be excluded that the reforming device is designed with a burner-fired steam reformer or pre-reformer.

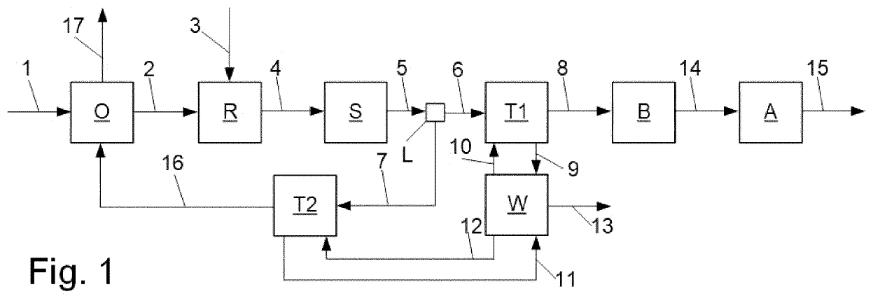

The invention is explained in more detail below using an exemplary embodiment schematically illustrated in FIG. 1.

The embodiment of FIG. 1 shows a preferred embodiment of the process according to the invention, in which an ammonia synthesis gas is produced as the hydrogen product using an autothermal reformer.

A carbonaceous feed, preferably methane, is fed into the burner-fired furnace O in order to be heated. Together with oxygen 3, the heated feed 2 is converted in the autothermal reformer R into a synthesis gas 4 comprising hydrogen, carbon monoxide and water, from which a synthesis gas 5 consisting largely of hydrogen and carbon dioxide is obtained in the water gas converter S. Via the flow divider L, the synthesis gas 5 is separated into a first 6 and a second synthesis gas substream 7, of which the first 6 is fed to the first CO₂ separation device T1, designed as an acid gas scrubber, and the second (7) is fed to the second CO₂ separation device T2, also designed as an acid gas scrubber.

In the first CO₂ separation device T1, an amine scrubbing agent is preferably used to separate carbon dioxide from the first synthesis gas substream 6 and to obtain a hydrogen-rich gas fraction 8 comprising carbon monoxide, methane and carbon dioxide residues, referred to as crude hydrogen. To separate carbon dioxide, the scrubbing agent 9 loaded during the scrubbing process is fed to the scrubbing agent regeneration unit W, which supplies the first CO₂ separation device T1 with regenerated scrubbing agent 10. The second CO₂ separation device T2 is operated with the same scrubbing agent as the first CO₂ separation device T1, so that the scrubbing agent regeneration unit W can also be used to regenerate the scrubbing agent 11 loaded with carbon dioxide during the scrubbing of the second synthesis gas substream 7, from which the second CO₂ separation device T2 is also supplied with regenerated scrubbing agent 12. In the scrubbing agent regeneration unit W, the separated carbon dioxide 13 is produced with a purity that allows its disposal by sequestration or physical use (neither shown).

The crude hydrogen 8 is processed in the processing device B, for example, through a combination of methanation, partial condensation, nitrogen scrubbing and nitrogen admixture, to form an ammonia synthesis gas 14 which is in particular free of carbon monoxide and in which hydrogen and nitrogen are present in the stoichiometric ratio of 3:1 for the subsequent ammonia synthesis A. The ammonia 15 obtained in ammonia synthesis A is stored, for example, in liquid form (not shown).

The gas phase 16 obtained from the second synthesis gas substream 7 in the second CO₂ separation device T2 consists predominantly of hydrogen and contains only small amounts of carbon in the form of carbon monoxide, carbon dioxide and methane. The gas phase 16 is used as combustion gas in the burner-fired furnace O, and its combustion produces a flue gas 17 containing very little carbon dioxide. The size of the second synthesis gas substream 7 is adjusted via the flow divider L so that the amount of combustion gas 16 is sufficient to fully provide the heat required for heating the feed 1, eliminating the need to combust a carbonaceous fuel.

1. Process for producing a hydrogen product, in which a carbonaceous feed is converted by reforming and water gas conversion in order to obtain a hydrogen- and carbon dioxide-containing gas mixture referred to as synthesis gas, from which, in a first CO₂ separation step, the removal of carbon dioxide gives rise to crude hydrogen, and this is processed by at least one further process step to give the hydrogen product, wherein process heat is obtained by combustion of a fuel and carbon dioxide separated from the synthesis gas is disposed of by sequestration or sent to a physical use, wherein the synthesis gas is separated into a first and a second synthesis gas substream, of which the first is treated in the first CO₂ separation step in order to obtain the crude hydrogen, while a combustion gas consisting largely of hydrogen is formed from the second synthesis gas substream by the removal of carbon dioxide in a second CO₂ separation step and is combusted to obtain process heat.

2. Process according to claim 1, wherein the two CO₂ separation steps are carried out as acid gas scrubbing, wherein the same scrubbing agent is used in both acid gas scrubbing steps.

3. Process according to claim 2, wherein the scrubbing agent loaded with carbon dioxide in the first CO₂ separation step is regenerated together with the scrubbing agent loaded with carbon dioxide in the second CO₂ separation step.

4. Process according to claim 1, wherein the combustion gas consisting largely of hydrogen is combusted to generate steam or to preheat a feed for reforming or to heat a steam reformer or a pre-reformer.

5. Process according to claim 1, wherein the crude hydrogen gives rise to an ammonia synthesis gas by methanation, nitrogen scrubbing or nitrogen addition.

6. Process according to claim 1, wherein the reforming comprises an autothermal reforming, a partial oxidation, a steam reforming or a pre-reforming.

7. Apparatus for producing a hydrogen product, comprising a reforming device and a water gas converter connected to the reforming device, via which a carbonaceous feed can be converted into a synthesis gas containing hydrogen and carbon dioxide by reforming and water gas conversion, a first CO₂ separation device with which carbon dioxide can be separated from the synthesis gas in order to obtain crude hydrogen, which can give rise to the hydrogen product in at least one processing device connected to the first CO₂ separation device, and a combustion device in which a fuel can be combusted to generate process heat, wherein carbon dioxide separated from the synthesis gas can be disposed of by sequestration or sent to a physical use, wherein it comprises a second CO₂ separation device which is connected to the first CO₂ separation device via a flow divider, via which the synthesis gas can be divided into a first synthesis gas substream for introduction into the first CO₂ separation device and a second synthesis gas substream for introduction into the second CO₂ separation device, wherein the crude hydrogen can be obtained from the first synthesis gas substream in the first CO₂ separation device and carbon dioxide can be separated from the second synthesis gas substream in the second CO₂ separation device in order to obtain a combustion gas consisting largely of hydrogen for use in the combustion device.

8. Apparatus according to claim 7, wherein the first CO₂ separation device and the second CO₂ separation device are designed as acid gas scrubbers, which can be operated with the same scrubbing agent.

9. Apparatus according to claim 8, wherein the first CO₂ separation device and the second CO₂ separation device are connected to one another via a shareable scrubbing agent regeneration unit.

10. Apparatus according to claim 7, wherein the combustion device is a burner-fired furnace, a steam generator, a steam reformer or a pre-reformer.

11. Apparatus according to claim 7, wherein the processing device is connected to an ammonia synthesis plant and is designed to process the crude hydrogen into an ammonia synthesis gas which can be fed to the ammonia synthesis plant as feed gas.

12. Apparatus according to claim 11, wherein the processing device comprises a methanation, a partial condensation, a nitrogen wash or a nitrogen supply.

13. Apparatus according to claim 7, wherein the reforming device is designed with an autothermal reformer, a partial oxidation reactor, a steam reformer or a pre-reformer.
